(19) United States
(12) Patent Application Publication
(10) Pub. No.: US 2010/0211735 A1
(43) Pub. Date: Aug. 19, 2010

(54) STORAGE SYSTEM, STORAGE CONTROL DEVICE, RECEPTION CONTROL DEVICE, AND CONTROL METHOD

(75) Inventors: Norikatsu SASAKAWA, Kawasaki (JP); Hidekazu Kawano, Kawasaki (JP); Hiroshi Chiba, Kawasaki (JP); Jun Ishizaki, Kawasaki (JP); Hajime Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/706,336

(22) Filed: Feb. 16, 2010

(30) Foreign Application Priority Data
Feb. 17, 2009 (JP) 2009-33895

(51) Int. Cl. G06F 12/00; G06F 13/00

(52) U.S. Cl. 711/114; 711/154; 710/38; 711/E12.001

(57) ABSTRACT

A storage system, including a storing unit, which is configured to be connectable to an information processor, includes a communication data receiving unit, a path information extracting unit, a specifying information creating unit and an access controlling unit. The communication data receiving unit receives communication data transmitted from the information processor. The path information extracting unit extracts path information indicating a communication path between the information processor and the communication data receiving unit, from the communication data received by the communication data receiving unit. The specifying information creating unit creates specifying information indicating the information processor that is the transmission source of the communication data, based on the path information extracted by the path information extracting unit. The access controlling unit performs an access control on the storing unit corresponding to the communication data, based on the specifying information created by the specifying information creating unit.

### CROSS-REFERENCE TO RELATED APPLICATIONS

This application is based upon and claims the benefit of priority of the prior Japanese Patent Application No. 2009-33895, filed on Feb. 17, 2009, the entire contents of which are incorporated herein by reference.

### FIELD

The embodiment discussed herein is related to an access controlling technique for a storing unit in a storage system such as RAID (Redundant Arrays of Inexpensive Disks).

### BACKGROUND

In these days, there is known a blade server in which a plurality of servers is assembled in one box. Further, also in a storage system, there is known a storage blade device which realizes an integration environment of the storage device by mounting a plurality of storage blades (HDD units) in one box.

Among storage systems, the RAID system is known. The RAID system is a disk array system formed by combining a plurality of disk devices (for example, hard disks) to avoid data loss caused by a failure of the disk device and to improve the processing performance.

FIGS. 13 and 14 are views schematically illustrating the structure of a storage system of a comparison example. In the example illustrated in FIG. 13, a RAID device 500 is connected to a switch SW500, and two servers A and B are connected to a switch SW500.

The server A includes a Host Bus Adapter (HBA) 201a having a WWN (World Wide Name) “1111 (WWN=1111)” and the server B includes a HBA 201b having the WWN “2222 (WWN=2222)”.

The RAID device 500 includes a plurality of HDDs (Hard Disk Drive: not illustrated). One storing region in the HDDs can be assigned to the server A and the server B respectively as a volume. An example shown in FIG. 13 illustrates that a server A volume 501a is assigned to the server A and a server B volume 501b is assigned to the server B.

The RAID device 500 is provided with a channel adapter 102 and is connected to a switch 40 through the channel adapter 102. The WWN of the RAID device 500 is “5555 (WWN=5555)”.

The switch 40 controls transfer of data and commands between the respective servers A and B and the RAID device 500. The switch 40 includes a plurality of ports P01, P02, and P03. In FIGS. 13 and 14, the port P01 is represented as 41, the port P02 is represented as 42, and the port P03 is represented as 43. The port P01 is connected to the HBA 201a of the server A and the port P02 is connected to the HBA 201b of the server B, thereby enabling communications. The port P03 is connected to the channel adapter 102 of the RAID device 500, thereby enabling communications.

In the RAID system of the comparison example, a function called Host Affinity is known to avoid data destruction caused by unnecessary access from the servers A and B when a plurality of servers A and B are connected to the system.

The host affinity assures the security of data at a connection by a plurality of servers by exclusively managing the access to a specified volume in the RAID device 500 and prohibiting the access from a server including a WWN not defined previously.

In order to realize the host affinity, zoning of the HBAs 201a and 201b in the servers A and B and the RAID device 500 is performed, for example, in the switch 40, to set the paths, and setting of the host affinity function in the RAID device 500 is performed.

Specifically, at first, the zoning is performed on “WWN-1111 (Server A HBA#1 WWN-1111)” of the HBA 201a of the server A and “WWN-5555 (RAID WWN-5555)” of the RAID device 500. Further, the zoning is performed on “WWN-2222 (Server B HBA#2 WWN-2222)” of the HBA 201b of the server B and “WWN-5555 (RAID WWN-5555)” of the RAID device 500. The path setting of the switch 40 is thus performed through the zoning.

Next, the RAID device 500 is configured to direct an access from “WWN-1111” to the server A volume 501a (AFFINITY GROUP #G1). Similarly, an access from “WWN-2222” is directed to the server B volume 501b (AFFINITY GROUP #G2).

The above-mentioned setting of the host affinity function allows the server A volume 501a only the access from “WWN-1111” and the server B volume 501b only the access from “WWN-2222”.

In other words, an access from the server B to the server A volume 501a and an access from the server A to the server B volume 501b is prohibited in the RAID device 500 and the security of the data for each volume can be provided in the RAID device 500.

The HBA may be sometimes exchanged because of a breakdown or the like in the server. As illustrated in FIG. 14, when the HBA 201a of the server A is exchanged to the HBA 201c having the WWN “3333 (WWN=3333)”, the WWN of the HBA of the server A is switched from “1111” to “3333”.

Therefore, in the storage system of the comparison example, a system manager has to change the setting that allows the server A volume 501a only the access from “WWN-1111” to the setting that allows the server A volume 501a only the access from “WWN-3333”, in the AFFINITY GROUP #1, in order to operate the RAID system in the same way as before the exchange of the HBA.

Further, the system manager has to change the zoning of the HBA 201a and the RAID device 500 to the zoning of “WWN-3333” (Server A HBA#3 WWN-3333) of the HBA 201c and the RAID device 500, in the path setting of the switch 40.

Here, the storage system of the comparison example is provided with a system for monitoring the structure of the system, and when detecting a change in the HBA WWN of the server, a technique of newly updating the contents of the access control table of the storage device with a new WWN is known. The reference document is Japanese Laid-open Patent Publication No. 2006-338116.

The storage system of the comparison example, however, has a problem that the system manager has to do troublesome work such as changing the zoning and setting access control in the exchange of the server HBA.

Further, providing a system with a function for exclusive use for monitoring the system structure and updating the access control table of a storing unit, in order to reduce the loads for the above work, raises the cost for the system configuration and is inefficient.

### SUMMARY

According to an aspect of the invention, a storage system, including a storing unit, which is configured to be connectable to an information processor, includes a communication data receiving unit, a path information extracting unit, a specifying information creating unit, and an access controlling unit. The communication data receiving unit receives communication data transmitted from the information processor. The path information extracting unit extracts path information indicating a communication path between the information processor that is a transmission source of the communication data and the communication data receiving unit, from the communication data received by the communication data receiving unit. The specifying information creating unit creates specifying information indicating the information processor that is the transmission source of the communication data, based on the path information extracted by the path information extracting unit. The access controlling unit performs access control on the storing unit corresponding to the communication data, based on the specifying information created by the specifying information creating unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view schematically illustrating the hardware structure of a RAID device in a storage system as one example of the embodiment.

FIG. 2 is a view schematically illustrating the structure of the storage system as one example of the embodiment.

FIG. 3 is a view illustrating an example of RAID group information in the storage system as one example of the embodiment.

FIG. 4 is a view illustrating an example of volume information in the storage system as one example of the embodiment.

FIG. 5 is a view illustrating an example of host LUN correspondence information in the storage system as one example of the embodiment.

FIG. 6 is a view schematically illustrating the structure of an FC controlling unit in the storage system as one example of the embodiment.

FIG. 7 is a view illustrating an example of an FC command entry in the storage system as one example of the embodiment.

FIG. 8 is a view illustrating an example of FC header information in the storage system as one example of the embodiment.

FIG. 9 is a view illustrating an example of SCSI command information in the storage system as one example of the embodiment.

FIG. 10 is a view illustrating an example of AFFINITY LUN in the storage system as one example of the embodiment.

FIG. 11 is a view illustrating an example of FC setting information in the storage system as one example of the embodiment.

FIG. 12 is a flow chart describing creating processing of the AFFINITY LUN at a communication data receiving time in the storage system as one example of the embodiment.

FIG. 13 is a view schematically illustrating the structure of the storage system of a comparison example.

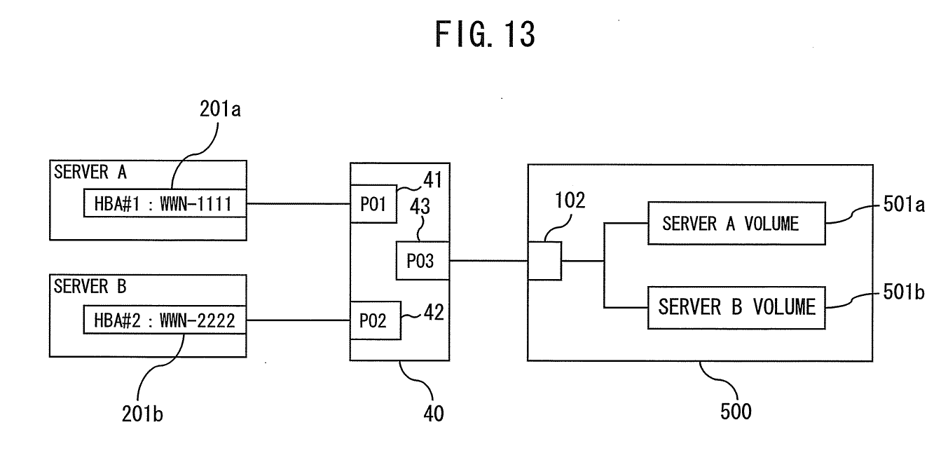

FIG. 14 is a view schematically illustrating the structure of the storage system of the comparison example.

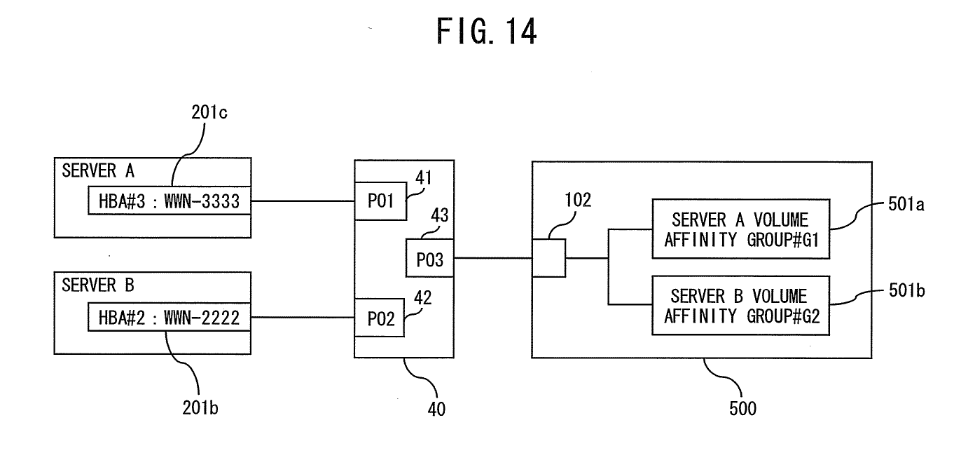

### DESCRIPTION OF EMBODIMENTS

Hereinafter, an embodiment related to a storage system, a storage control device, a reception control device, and a control method will be described with reference to the drawings.

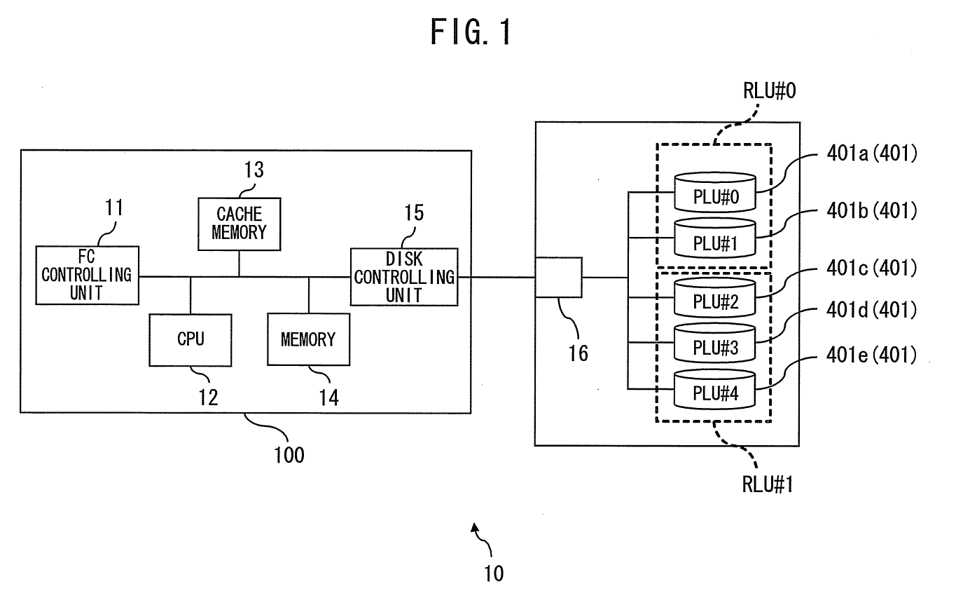

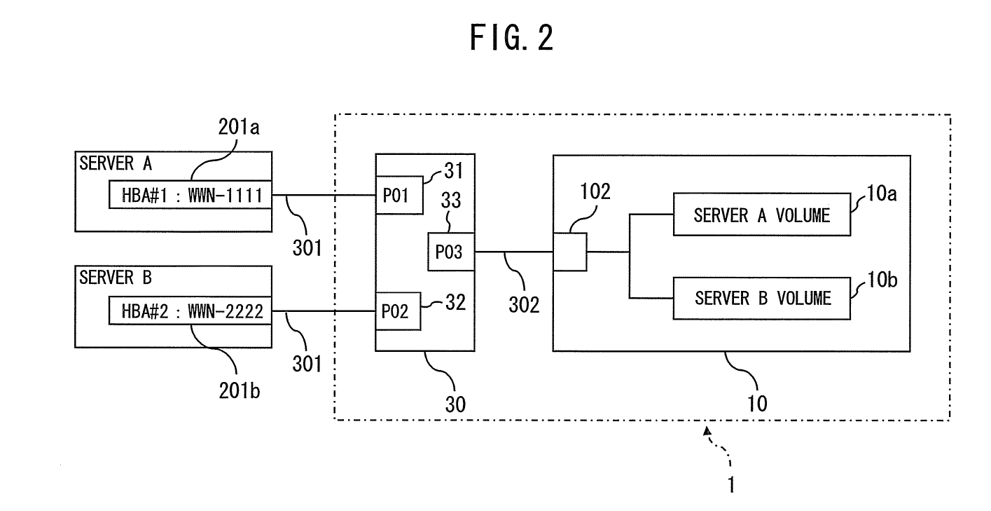

FIG. 1 is a view schematically illustrating the hardware structure of a RAID device in a storage system as one example of the embodiment. FIG. 2 schematically illustrates the structure of a storage system as one example of the embodiment.

A storage system 1 of the embodiment includes an FC switch (relay unit) 30 and a RAID device (storage control device) 10, as illustrated in FIG. 2, and the storage system 1 is communicably connected to a plurality of servers A and B (two in the example of FIG. 2) through the FC switch 30.

Each of the servers A and B is a computer (information processor) having a server function. The servers A and B write data into a storing region (volume; not illustrated) of the RAID device 10 and read data from the storing region by transmitting FCP (Fiber Channel Protocol) commands to the RAID device 10.

The FCP command is a command for use in a fiber channel protocol, for example, an SCSI (Small Computer System Interface) command.

The FCP command data transmitted from the servers A and B to the RAID device 10 is transmitted as FC data frames (communication data). The servers A and B gain access to a volume of the RAID device 10, using a LUN (Logical Unit Number).

In the storage system 1, the servers A and B, and the FC switch 30, and the RAID device 10 are respectively formed into the shape of a blade having the same size predetermined by a standard, and are inserted into one box, which is formed as a blade system (blade type storage system) that may accommodate a plurality of devices.

In the embodiment, the RAID device 10 includes a volume (server A volume 10a) that allows only an access from the server A so that the server A may read and write data, and a volume (server B volume 10b) that allows only an access from the server B so that the server B may read and write data.

The server A is removably provided with a host bus adapter (HBA) 201a and the server B is removably provided with a HBA 201b respectively. The HBAs 201a and 201b are interfaces for connecting the external devices such as a storage device to the main bodies of the servers A and B, each having an inherent WWN.

In the example, “1111 (WWN=1111)” is set as the WWN for the HBA 201a and “2222 (WWN=2222)” is set as the WWN for the HBA 201b.

Here, as a reference mark indicating the HBA, when each one of the HBAs is specified, the respective reference marks 201a and 201b are used, while when a HBA is not specified, the reference mark 201 is collectively used. The HBA 201a may be sometimes represented as HBA#1 and the HBA 201b may be sometimes represented as HBA#2.

The FC switch 30 controls the transfer of data and commands between the servers A and B and the RAID device 10. The FC switch 30 is provided with a plurality (three in the example of FIG. 2) of ports P01, P02, and P03. In FIG. 2, the port P01 is represented as 31, the port P02 is represented as 32, and the port P03 is represented as 33. The HBA 201a of the server A is communicably connected to the port P01 through a communication line 301. The HBA 201b of the server B is communicably connected to the port P02 through the communication line 301. Further, the channel adapter 102 of the RAID device 10 is communicably connected to the port P03 of the FC switch 30 through a communication line 302.

As illustrated in FIG. 1, the RAID device 10 is made up of a RAID controller 100 and a plurality (five in the example of FIG. 1) of storing units 401a, 401b, 401c, 401d, and 401e which are communicably connected to the RAID controller 100 through a switch 16. The RAID device 10 realizes a disk array system with a combination of a plurality of storing units 401a, 401b, 401c, 401d, and 401e as a RAID group.

The storing units 401a, 401b, 401c, 401d, and 401e are storing units for storing data in readable and writable way, for example, an HDD. Here, the storing units 401a, 401b, 401c, 401d, and 401e are sometimes represented as PLU#0, PLU#1, PLU#2, PLU#3, and PLU#4 respectively.

Hereinafter, when each one of the storing units is specified, the reference marks respectively indicating the storing units 401a, 401b, 401c, 401d, and 401e or PLU#0 to PLU#4 are used; while when the storing units are not referred to specifically, the reference mark 401 is used as a whole.

A switch 16 connects the plurality of storing units 401 to the RAID controller 100. The switch 16 passes the read data read out from the storing unit 401 to a disk controlling unit 15 and passes the write data transmitted from the disk controlling unit 15 to the storing destination storing unit 401.

According to the storage system 1, a plurality of RAID groups may be formed in the RAID device 10. In the example of FIG. 1, according to the function of the RAID device 10, the storing units 401a and 401b (PLU#0, PLU#1) form a parity group of the RAID group RLU#0. Similarly, the storing units 401c, 401d, and 401e (PLU#2, PLU#3, PLU#4) form a parity group of the RAID group RLU#1.

The function of forming a RAID group by a plurality of storing units 401 may be realized by using a known method; therefore, the description is omitted here. Hereinafter, information about the RAID group in the storage system 1 will be referred to as RAID group information.

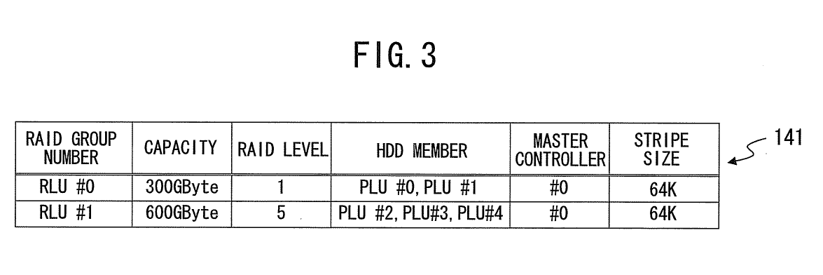

FIG. 3 is a view illustrating an example of the RAID group information in the storage system as an example of an embodiment.

In the example illustrated in FIG. 3, the RAID group information 141 includes a RAID group number, a capacity of the RAID group, a RAID level, an HDD member, a master controller, and a stripe size.

The RAID group number is the identification information for specifying a RAID group, and in the example illustrated in FIG. 3, RLU#0 and RLU#1 are illustrated. The capacity is a storage capacity of a RAID group, and in the example illustrated in FIG. 3, the RAID group RLU#0 contains the capacity of 300 GByte and the RAID group RLU#1 contains 600 GByte.

The RAID level indicates the RAID level of a RAID group, and in the example illustrated in FIG. 3, the RAID group RLU#0 is the RAID level 1 (RAID 1) and the RAID group RLU#1 is the RAID level 5 (RAID 5).

The HDD member indicates the information for specifying each storing unit forming a RAID group. In the example illustrated in FIG. 3, the storing units 401a and 401b (PLU#0, PLU#1) form the RAID group RLU#0 and the storing units 401c, 401d, and 401e (PLU#2, PLU#3, PLU#4) form the RAID group RLU#1.

The master controller is information for specifying the RAID controller 100 which controls the RAID groups. When the RAID device 10 is provided with a plurality of RAID controllers 100, information (a number, etc.) for specifying the respective RAID controllers 100 which manage the respective RAID groups is registered. Namely, the RAID device 10 may be provided with a plurality of RAID controllers 100.

In the embodiment, the RAID device 10 is provided with only one RAID controller 100 and in FIG. 3, the master controller #0 is registered for both RAID groups RLU#0 and RLU#1.

The stripe size is the unit of writing data into the storing unit 401 and may be arbitrarily changed by a system manager for example. In the example illustrated in FIG. 3, 64k is set for both RAID groups RLU#0 and RLU#1. The stripe size may be changed arbitrarily.

In the storage system, respective specified volumes may be exclusively assigned to respective servers A and B connected to the RAID device 10. Specifically, at least one region of the parity groups formed as the RAID groups RLU#0 and RLU#1 is assigned to the servers A and B respectively as a volume. The information about the volume thus set is referred to as volume information.

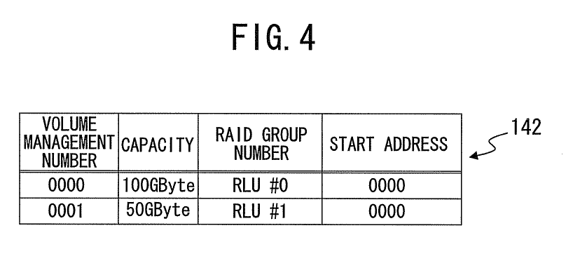

FIG. 4 is a view illustrating an example of the volume information in the storage system as an example of an embodiment.

In the example illustrated in FIG. 4, the volume information 142 includes a volume management number, a capacity of a region assigned to the volume, the RAID group number, and a start address.

The volume management number is the identification information set for specifying a volume. The capacity indicates the size of a region assigned to the volume. The start address is an address indicating the start position of the volume.

In the example illustrated in FIG. 4, the region of 100 GByte starting from the address “0000” in the RAID group RLU#0 is the volume management number “0000”, and the region of 50 GByte starting from the address “0000” in the RAID group RLU#1 is the volume management number “0001”.

The volume information 142 is provided in every server. Hereinafter, in the embodiment, a description will be made, for convenience's sake, taking an example of forming the volumes of the volume management number “0000” and the volume management number “0001” for use in the server A volume.

The RAID controller 100 realizes a RAID function while controlling a plurality of the storing units 401, receives FC data frames (communication data) transmitted from the servers A and B through the FC switch 30 by the frame units, and performs various controls and operations on the storing unit 401 according to the communication data.

This RAID controller 100 includes an FC controlling unit 11, a CPU 12, a cache memory 13, a memory 14, and the disk controlling unit 15, as illustrated in FIG. 1.

The FC controlling unit 11 receives communication data transmitted from the servers A and B through the FC switch 30, and performs the relay processing for passing the received communication data to the downstream CPU 12 and disk controlling unit 15. The detailed structure of the FC controlling unit 11 will be described later.

The cache memory 13 is a storing unit for temporarily storing the communication data passed from the FC controlling unit 11, and functions as, for example, a buffer.

The CPU 12 performs various controls and operations for realizing the RAID, and to control access to a plurality of the storing units 401. The CPU 12 controls the disk controlling unit 15 to write data into the storing unit 401 and read the stored data therefrom, according to, for example, a SCSI command transmitted from the servers A and B, based on RAID control information stored in the memory 14.

The CPU 12 realizes a RAID function using a plurality of the storing units 401, according to RAID group information 141 and volume information 142. The detailed method of controlling access to the storing unit 401 by the CPU 12 will be described later.

The disk controlling unit 15 writes data into a specific storing region of the storing unit 401 and reads data stored in a specific storing region of the storing unit 401.

The memory 14 is a storage, for example, a RAM (Random Access Memory), for storing various data and stores the RAID group information 141 and the volume information 142. The memory 14 stores host LUN correspondence information 143.

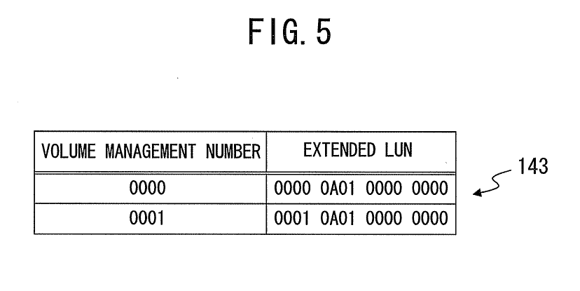

FIG. 5 is a view illustrating an example of the host LUN correspondence information 143 in the storage system as an example of an embodiment.

The host LUN correspondence information 143 is formed by the correspondence of volume management number and an extended LUN.

The extended LUN is formed by adding path information indicating the respective communication paths (transmission paths) between the respective servers A and B and the RAID device 10 or their physical connection state, to the LUN used for the servers A and B to recognize the volume of the RAID device 10.

Namely, the extended LUN is storage access information including the path information indicating the respective communication paths between the respective servers A and B and the RAID controller 100.

A description will be made, for example, in the storage system 1 formed as illustrated in FIG. 2, taking an example of creating a LUN 0000 (volume management number 0000) for a 100 GByte region and creating a LUN0001 (volume management number 0001) for a 50 GByte region as the server A volume.

In the storage system 1 illustrated in FIG. 2, the HBA 206a for the server A is connected to the port P01 of the FC switch 30 (switch number: 0A) through a communication line 301. The HBA 206b for the server B is connected to the port P02 of the FC switch 30 (switch number: 0A) through the communication line 301. Here, it is assumed that in the RAID device 10, the storing units 401 are not loop connected.

In this structure, for example, a manager of the storage system 1 creates an extended LUN with a terminal device not illustrated.

Specifically, at first, the manager creates the path information for the server A, like “0A0100 (hexadecimal)”, by combining the switch ID “0A (hexadecimal)” that is the identification information for specifying that the server A is connected to the switch 30 (switch number: 0A), the port ID “01 (hexadecimal)” that is the identification information for specifying the port P01 to which the server A is connected in the FC switch 30, and the loop ID “00 (hexadecimal)” that is the identification information indicating that the connection is not a loop connection.

Namely, the storage system 1 holds the address of the HBA 201a for the server A, represented by the communication path “0A0100”.

Further, by combining the “0000” indicating the LUN “0000” from the viewpoint of the server A with the upper side of the above path information “0A0100”, the path information indicating the physical connection state of the server A is created as “0000 0A01 00 (hexadecimal).

Here, in fiber channel standards, the created path information “0000 0A01 00” is converted into 8 Bytes, taking into consideration that the LUN is 8 Bytes.

Specifically, for example, as illustrated in the below, the path information “0000 0A01 00” is aligned to 8 Bytes through a bit operation of adding “0000 0000 0000” of 8 Bytes to the above.

0000 0A01 00+0000 0000 0000=0000 0000 000A 0100

Further, the above value “0000 0000 000A 0100” converted into 8 Bytes is bit-shifted to a higher position by 24 bits according to the bit shift method. When the path information is expressed in a hexadecimal bit string in the embodiment, the left side in the bit string is expressed as a higher position and the right side is expressed as a lower position in some cases.

According to this bit shift, the extended LUN “0000 0A01 0000 0000” is created. Namely, in the process of the bit shift, “0” or “000000 (hexadecimal)” is set in the lower 24 Bits of the path information.

Similarly, by combining the “0001” indicating the LUN “0001” from the viewpoint of the server A to the higher position of the above-mentioned path information “0A0000”, the path information is created as “0001 0A01 00 (hexadecimal)”.

Further, the created path information “0001 0A01 00” is converted into 8 Bytes (digit alignment). For example, the path information “0001 0A01 00” is converted into 8 Bytes through the bit operation of adding the path information to the 8 Bytes “0000 0000 0000”, as illustrated below.

0001 0A01 00+0000 0000 0000=0000 0000 010A 0100

Further, the above value “0000 0000 010A 0100” converted into 8 Bytes is bit shifted to a higher position by 24 bits, using the bit shift method, to create the extended LUN “0001 0A01 0000 0000”. In the process of the bit shift, “0” or “000000 (hexadecimal)” is set in the lower 24 Bits of the path information.

In the storage system, a server generally performs transfer of communication data, using the front 2 Bytes of the LUN. In the storage system 1, through the above-mentioned bit shift operation, “0000” indicating the LUN “0000” and “0001” indicating the LUN “0001” from the viewpoint of the server are arranged at the front 2 Bytes of the extended LUN.

With respect to the server B, an extended LUN is similarly created for every volume. The above-mentioned created extended LUN is stored (registered) into the memory 14 as the host LUN correspondence information 143.

Hereafter, the RAID group information 141, the volume information 142, and the host LUN correspondence information 143 are sometimes referred to as RAID control information.

A manager of the storage system 1 may create the extended LUN and register the extended LUN into the host LUN correspondence information 143, or the above-mentioned process may be performed by the CPU 12 of the RAID device 10 and a management device not illustrated. Various modifications may be performed without departing from the spirit of the embodiment.

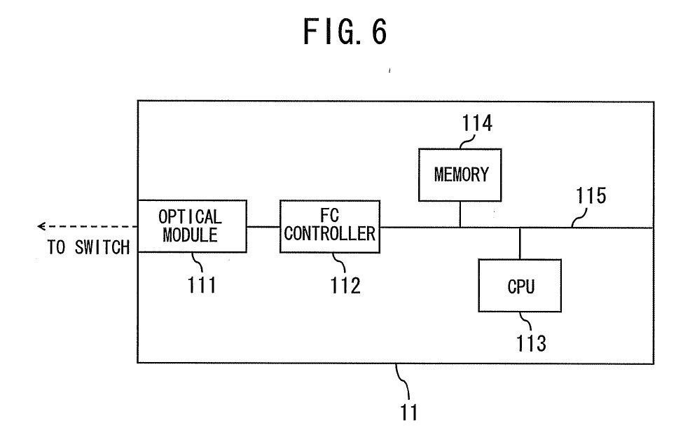

FIG. 6 is a view schematically illustrating the structure of the FC controlling unit in the storage system as one example of the embodiment.

The FC controlling unit 11 includes an optical module 111, an FC controller 112, a memory 114, and a CPU 113 which are mutually and communicably connected to each other through a 115 bus, as illustrated in FIG. 6.

The optical module 111 is an interface which receives the FC data frames (communication data) transmitted from the servers A and B through the FC switch 30 and converts the optical signals entered through the FC switch 30 into digital signals. Namely, the optical module 111 is a communication data receiving unit which receives the communication data transmitted from the servers A and B.

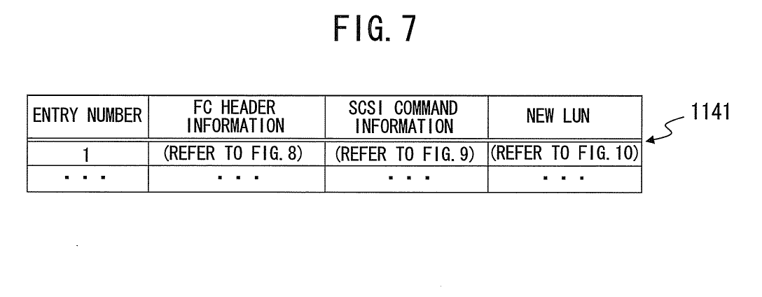

The memory 114 is a memory for storing various data in a readable way. This memory 114 works, for example, as a buffer which temporarily stores the communication data converted by the FC module 111. The memory 114 has an FC command entry 1141 as illustrated in FIG. 7.

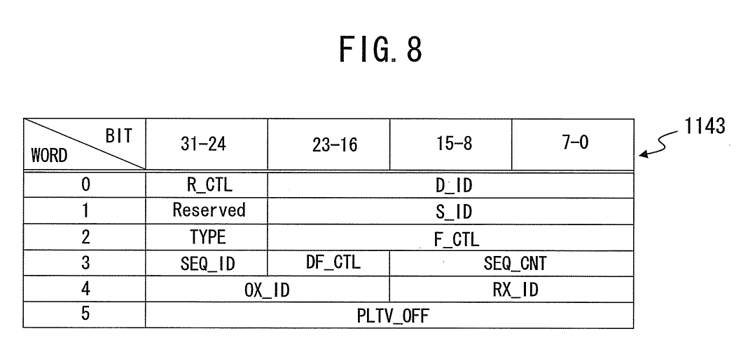

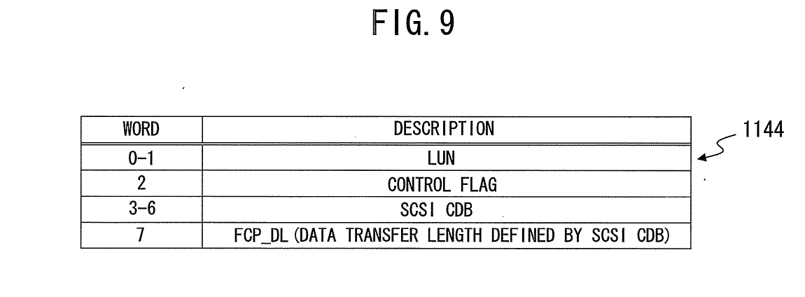

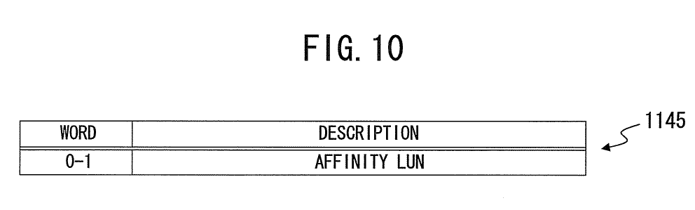

FIG. 7 is a view illustrating an example of the FC command entry 1141 in the storage system as one example of the embodiment; FIG. 8 is a view illustrating an example of FC header information; FIG. 9 is a view illustrating an example of SCSI command information; and FIG. 10 is a view illustrating an example of AFFINITY LUN.

As illustrated in FIG. 7, the FC command entry 1141 is a storing region for storing the respective fields of an entry number, FC header information, SCSI command information, and a NEW LUN in association with each other. In the example illustrated in FIG. 7, for convenience's sake, the FC command entry 1141 is expressed in the form of a table including the respective items of the entry number, FC header information, SCSI command information, and the NEW LUN.

In the FC command entry 1141, the FC header information, the SCSI command information, and the NEW LUN are stored for every FC data frame in association with each other. Further, in the FC command entry 1141, each entry number is set for every received FC data frame, by the FC controller 112 or the CPU 113.

The FC header information 1143 is information about the communication data (FC data frames) by frame units converted into digital data by the optical module 111, is transmitted from the servers A and B, and includes information indicating the transmission source and destination such as R_CLT, S_ID, D_ID, for example, as illustrated in FIG. 8. Especially, S_ID includes the switch ID of the FC switch 30, the port ID, and the loop ID on the transmission path of the FC data frame.

This FC header information 1143 is stored mainly in the frame header portion of the FC data frame, and the FC controller 112 extracts the information from the communication data obtained by the optical module 111 and stores the information as the FC header information 1143.

The SCSI command information 1144 is information about SCSI commands transmitted from the servers A and B, and is stored mainly in the data (payload) in the FC data frame. Specifically, the SCSI command information includes a LUN, a control flag, SCSI CDB, and FCP_DL (data transfer length defined by SCSI CDB), for example, as illustrated in FIG. 9. The LUN included in the SCSI command information 1144 is the LUN which the servers A and B of the transmission source use for transmission of the FC data frames.

Various information indicated as the FC header information 1143 and the SCSI command information 1144 in FIGS. 8 and 9 is based on the fiber channel standards defined as FC-PI (Fiber Channel Physical Interface) by the ANSI (American National Standards Institute). Since the above information is generally defined as the FP-PI, concrete description is omitted.

The NEW LUN stores the AFFINITY LUN 1145 (details will be described later) of 8 Bytes created by the CPU 113 converting the LUN of the communication data converted by the optical module 11 (refer to FIG. 10).

The memory 114 previously stores the FC setting information 1142.

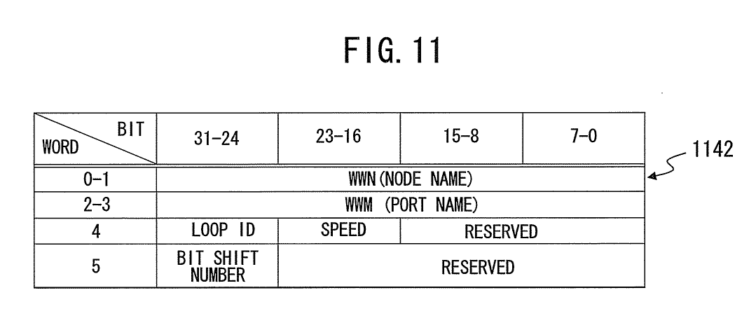

FIG. 11 is a view illustrating an example of the FC setting information in the storage system as an example of an embodiment.

The FC setting information 1142 is information about the setting of the FC controlling unit 11, including WWN, WWM, LOOP ID, SPEED, and BIT shift number, for example, as illustrated in FIG. 11. Here, the BIT shift number is the value (the number of bits) for use when the CPU 113 described later creates the AFFINITY LUN, and an arbitrary value (24 Bits in the embodiment) may be previously set by a manager. The WWN, WWM, LOOP ID, and SPEED are the information generally used in the fiber channel standards and therefore the description is omitted.

The FC controller 112 controls the flow of the communication data converted by the optical module 111. The FC controller 112 stores the received FC data frames into the memory 114.

The FC controller 112 extracts the FC header information and SCSI command information from the FC data frame received through the optical module 111 and stores the above information into the FC command entry 1141.

Namely, the FC controller 112 works as a path information extracting unit which extracts the path information indicating the communication paths between the servers A and B, the transmission sources of the communication data, and the RAID device 10.

As a method of extracting the FC header information and the SCSI command information from the FC data frames, various kinds of known methods may be used. For example, a specific region in a storing region where the FC data frames are temporarily stored may be secured by hardware or software. Various modifications may be performed without departing from the spirit of the embodiment.

The CPU 113 is a processor for performing various controls and operations by executing a program stored in the memory 114 or ROM (not illustrated). For example, the CPU 113 works as a specified information creating unit which creates specified information indicating a transmission source server of the FC data frame based on the information stored in the FC command entry 1141 of the memory 114.

Specifically, the CPU 113 obtains a switch ID, a port ID, and a loop ID from the S_ID of the FC header information of the FC command entry 1141 in the memory 114. Namely, the CPU 113 obtains the path information from the transmission source server to the RAID device 10, for the FC data frame corresponding to the S_ID of the FC header information in the FC command entry 1141.

Further, the CPU 113 obtains the LUN added to the FC data frames by the transmission source servers A and B, from the SCSI command information. The LUN is generally formed as the information of 8 Bytes according to the fiber channel standards.

Then, the CPU 113 creates AFFINITY LUN, using the obtained path information (switch ID, port ID, and loop ID) and LUN. The AFFINITY LUN is created by the CPU 113 in substantially the same method as that of the extended LUN.

The CPU 113 creates the path information of the FC data frame, at first by combining the switch ID, the port ID, and the loop ID obtained from the S_ID of the FC header information.

Further, the CPU 113 converts the created path information into the data of 8 Bytes, taking into consideration that the 8-byte LUN based on the fiber channel standards is generally used. For example, the CPU 113 creates the path information of 8 Bytes through the bit operation for digit alignment of the LUN.

The CPU 113 creates the storage information by bit shifting the created path information of 8 Bytes to a higher position by 24 Bits. In the process of the bit shift, “0” or “000000 (hexadecimal)” is set in the lower 24 Bits in the store information.

The CPU 113 creates the AFFINITY LUN of 8 Bytes through the bit operation of adding the path information converted into 8 Bytes to the LUN obtained from the SCSI command information.

Hereinafter, a concrete method of creating the AFFINITY LUN will be described taking the FC data frame transmitted from the server A to the LUN “0001 0000 0000 0000” as an example.

The CPU 113 creates the path information “0A0100 (hexadecimal)” by combining the switch ID “0A (hexadecimal)” indicating the FC switch 30 with the port ID “01 (hexadecimal)” and the loop ID “00 (hexadecimal)”, according to the S_ID of the FC header information.

Further, the CPU 113 aligns the created path information “0A0100” to 8 Bytes. Namely, the path information “0A01 00” is converted into the data of 8 Bytes through the bit operation of adding the path information “0A01 00” to “0000 0000 0000” of 8 Bytes, for example, as illustrated in the following expression.

0A01 00+0000 0000 0000=0000 0000 000A 0100

The CPU 113 creates the store information “0000 0A01 0000 0000” through bit shift of shifting the value “0000 0000 000A 0100” aligned to 8 Bytes to a higher position by 24 Bits, using the bit shift method. Namely, the CPU 113 sets “0” or “000000 (hexadecimal)” in the lower 24 Bits of the path information and arranges the path information “0A01 00” in the upper position, in the process of the bit shift.

The CPU 113 obtains the LUN “0001 0000 0000 0000” from the SCSI command information and creates the AFFINITY LUN “0001 0A01 00 (hexadecimal)” by combining this LUN with the created store information “0000 0A01 0000 0000” of 8 Bytes, as illustrated in the following expression.

0001 0000 0000 0000+0000 0A01 0000 0000=0001 0A01 0000 0000

The CPU 113 registers the created AFFINITY LUN “0001 0A01 00” into the NEW LUN of the command entry 1141.

In the RAID device 10, the AFFINITY LUN created by the CPU 113 is transferred to the processing inside the RAID as an access destination LUN.

The CPU 113 checks whether the FC data frame is the SCSI command by referencing the R_CTL of the FC header information in the FC command entry 1141. Namely, the CPU 113 works as a judging unit which judges whether the communication data is a storage access command or not.

When the FC data frame is not the SCSI command but the control information, the CPU 113 will not create (convert) the above-mentioned AFFINITY LUN corresponding to the FC data frame. This is why the control information does not depend on LUN in the RAID device 10. Thus, the load of the CPU 113 may be reduced.

In the storage system 1, the CPU 113 of the FC controlling unit 11 provided in the RAID controller 100 executes the program stored in the memory 114 or ROM (Read Only Memory) not illustrated, hence to realize the respective functions as the specified information creating unit, the storage access information processing unit, and the judging unit as mentioned above.

A program for realizing the functions of the specified information creating unit, the storage access information processing unit, and the judging unit is provided in the form of a computer readable recording medium, for example, flexible disk, CD (CD-ROM, CD-R, CD-RW or the like), DVD (DVD-ROM, DVD-RAM, DVD-R, DVD+R, DVD-RW, DVD+RW, HD DVD or the like), Blu-ray disk, magnetic disk, optical disk, and optical magnetic disk. A computer reads out the program from the recording medium, transfers the program to an internal storing unit or external storing unit, and stores the program therein. Alternatively, the program may be recorded in a recording device (recording medium), for example, magnetic disk, optical disk, optical magnetic disk and the like and provided to a computer through a communication path.

In the process of realizing the functions as the specified information creating unit, the storage access information processing unit, and the judging unit, the program stored in the internal storing unit (memory 114 and ROM in the embodiment) is executed by a microprocessor (CPU 113 in the embodiment) of a computer. Here, the program recorded in the recording medium may be read and executed by the computer.

In the embodiment, a concept of a computer refers to hardware and an operating system, indicating the hardware operating under a control of the operating system. When an application program itself runs the hardware without any operating system, the hardware itself corresponds to a computer. The hardware is provided with at least a microprocessor such as CPU and a unit for reading a computer program recorded in a recording medium and, in the embodiment, the FC controlling unit 11 includes the function of a computer.

In the RAID controller 100, the CPU 12 refers to the host LUN correspondence information 143 stored in the memory 14, according to the AFFINITY LUN created by the FC controlling unit 11. Then, the CPU 12 requires the extended LUN which is in agreement with the AFFINITY LUN of the host LUN correspondence information 143, to obtain the volume management number.

For example, in the case of the AFFINITY LUN “0001 0A01 0000 0000”, the CPU 12 obtains the volume management number “0001” of the extended LUN which is in agreement with the AFFINITY LUN “0001 0A01 0000 0000”, by referencing the host LUN correspondence information 143.

The CPU 12 obtains the volume information managed according to the volume management number, by referencing the volume information 142 based on the obtained volume management number.

For example, the CPU 12 refers to the volume information 142 based on the volume management number “0001” to find that the target parity group is the RAID group RLU#1 and that the volume has been assigned, according to the address “0000”.

Further, the CPU 12 refers to the RAID group information 141, based on the target parity group (RAID group) obtained by referring to the volume information 142, to obtain the information on the storing unit 401 for gaining access. The CPU 12 gains access to a specific region of the target storing unit 401, using the disk controlling unit 15, according to the obtained information.

For example, by referring to the RAID group information 141 based on the RAID group RLU#1, the CPU 12 learns that the RAID group RLU#1 is formed by the storing units 401c, 401d, and 401e (PLU#2, PLU#3, PLU#4) which are used in the RAID 5.

The CPU 12 gains access to the storing units 401c, 401d, and 401e (PLU#2, PLU#3, PLU#4) using the disk controlling unit 15.

When the disk controlling unit 15 has gained access to the specific region of the storing unit 401, the disk controlling unit 15 returns the completion notice to the CPU 12. The completion notice is also returned to the FC controlling unit 11, and in the FC controlling unit 11, the CPU 113 is notified of the completion, according to the entry number in the FC command entry 1141. Based on the completion notice, the FC controlling unit 11 sends the normal notification on the FC to the OX-ID command of the WORD4 in the FC header information.

In the storage system 1, the CPU 12 in the RAID controller 100 executes a program stored in the memory 14 and the ROM (Read Only Memory) (not illustrated) to realize a function of the above-mentioned access controlling unit.

The program for realizing the function of the access controlling unit is provided in the form of a computer readable recording medium, for example, flexible disk, CD (CD-ROM, CD-R, CD-RW), DVD (DVD-ROM, DVD-RAM, DVD-R, DVD+R, DVD-RW, DVD+RW, HD DVD, etc.), Blu-ray disk, magnetic disk, optical disk, and/or optical magnetic disk. A computer reads the program from the recording medium, transfers the program to the internal storing unit or external storing unit, and stores the program therein. Alternatively, the program may be recorded in a recording unit (recording medium), for example, a magnetic disk, optical disk, optical magnetic disk and the like and provided to a computer through a communication path.

In the process of realizing the functions as the access controlling unit, the program stored in the internal storing unit (memory 114 and ROM in the embodiment) is executed by the microprocessor (CPU 12 in the embodiment) of a computer. Here, the program recorded in the recording medium may be read and executed by the computer.

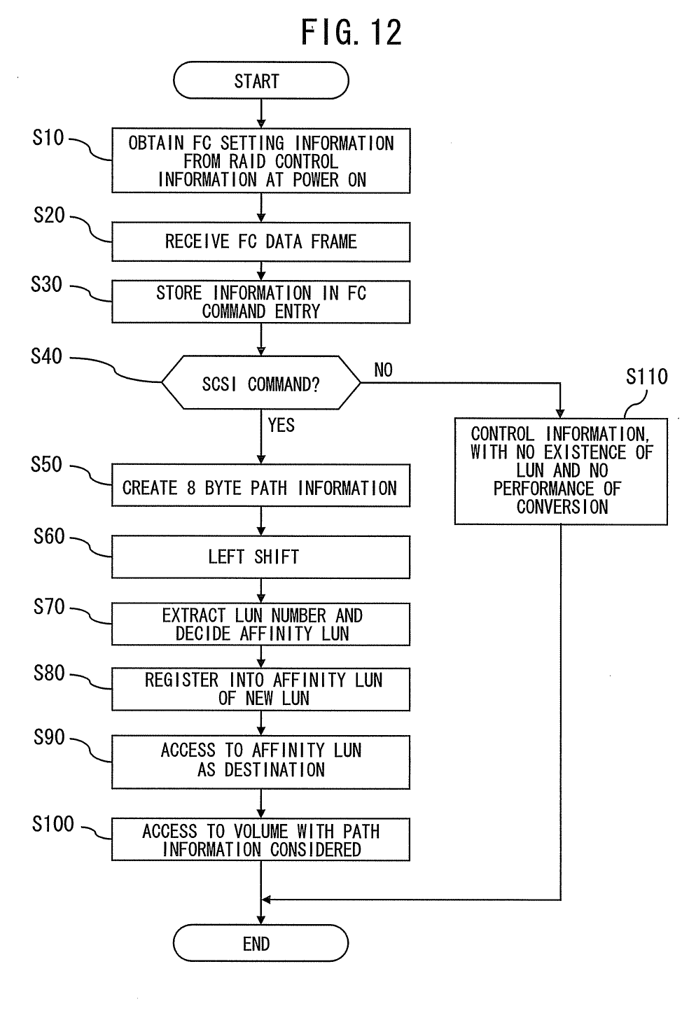

The process of creating the AFFINITY LUN at a communication data receiving time in the storage system as an example of an embodiment as mentioned above, will be described with reference to the flow chart (operation S10 to S110) illustrated in FIG. 12.

In the RAID device 10, it is assumed that the RAID control information is previously stored in the memory 14.

When the RAID device 10 starts up (POWER ON), the CPU 12 obtains the FC setting information 1142 from the memory 14 in the starting up process (operation S10).

In the servers A and B, read and write commands are issued for the LUN 0000 and the LUN 0001 similarly to the comparison example, when accessing the volume.

When the servers A and B transmit the communication data (FC data frames) of the commands, the FC controlling unit 11 receives the FC data frames (operation S20), and the FC data frames received and converted by the optical module 111 are temporarily stored in the buffer (memory 114).

The FC controller 112 extracts the FC header information and the SCSI command information from the frame header of the received FC data frames and the payload portion and stores the extracted information in the FC command entry 1141 for every FC data frame (operation S30).

The CPU 113 checks whether the FC data frame is the SCSI command (storage access command) or not (operation S40: checking operation), by referencing the R_CTL of the FC header information in the FC command entry 1141.

When the FC data frame is not the SCSI command (NO in operation S40), the FC data frame is considered to be the control information. Since the control information does not depend on the LUN, the FC controlling unit 11 will not perform the conversion processing for converting the LUN of the FC data frame related to the control information into the AFFINITY LUN. Namely, the FC controlling unit 11 passes the FC data frame to the downstream CPU 12 without creating the AFFINITY LUN (operation S110). The CPU 12 performs the processing related to the control information.

When the FC data frame is the SCSI command (YES in operation S40), the CPU 113 obtains the switch ID, the port ID, and the loop ID from the FC header information S_ID of the FC command entry 1141. The CPU 113 creates the path information of 8 Bytes, according to the obtained switch ID, port ID, and loop ID (operation S50).

Further, the CPU 113 performs the bit shift (left shift) on the created path information by 24 bits, using the bit shift method to set “0” or “000000 (hexadecimal) in the lower 24 Bits of the path information (operation S60). The CPU 13 obtains the number of bits shifted (shift amount) from the BIT shift number in the FC setting information 1142.

The CPU 113 extracts the LUN from the SCSI command information in the FC command entry 1141 and performs the bit addition of the LUN and the path information (S_ID) created through the bit shift in the operation S60. Accordingly, the AFFINITY LUN for gaining access within the RAID device 10 is created (operation S70).

The CPU 113 registers the value created in the operation S70 into the AFFINITY LUN of the NEW LUN field in the FC command entry 1141 (operation S80).

The FC controlling unit 11 transmits the entry information with the created AFFINITY LUN as an access destination, to the CPU 12, where an access to the storing unit 401 is performed (operation S90). The CPU 12 gains access to the volume corresponding to the transmitted AFFINITY LUN (operation S100). Specifically, the CPU 12 refers to the host information 143, the volume information 142, and the RAID group information 141, based on the AFFINITY LUN and gains access to a specific region in the corresponding storing unit 401 to do the data reading and writing processing.

As mentioned above, according to the storage system 1 as one example of the embodiment, the AFFINITY LUN with the path information of the source servers A and B added is created for the received FC data frame, in the FC controlling unit 11, and the access to the storing unit 401 is controlled based on the AFFINITY LUN in the RAID controller 100. Accordingly, it is possible to control the access to the volume in the RAID device 10 without using WWNs of the HBAs 201a and 201b of the servers A and B.

Accordingly, when the HBA 201 is exchanged, for example, due to a failure or the like and the WWN is changed in the server, an access to a volume corresponding to a source server is continuously possible without any change in setting and operations in the RAID device 10. In short, it is possible to reduce the load for management and operations in the storage system 1.

Generally, in a storage system provided with the storing unit 401 and the FC switch 30, which is connected to a plurality of servers, when the HBA201 in some server is exchanged, a physical connection state of the HBA 201 and the port of the FC switch 30 is seldom changed in another server (having no failure) where the HBA 201 is not exchanged.

Especially, in a blade system with a plurality of servers and the FC switch concentrated in one housing, it is rare to change the connection relations between the FC switch 30 and the servers A and B after the system is configured. Namely, in the blade system, even when the HBA 201 of one server is exchanged in maintenance work, the new HBA 201 is usually connected to the same port of the FC switch 30 where the previous HBA 201 was connected. Accordingly, it is often the case where the physical connection relations (path) are not changed between the ports P01 and P02 of the FC switch 30, when exchanging the HBA 201.

In other words, the server A with the HBA 201a exchanged has a high possibility of being connected to the port P01 of the FC switch 30 again and the server B with the HBA 201b exchanged has a high possibility of being connected to the port P02 of the FC switch 30 again.

Therefore, like the storage system 1, a control of access to a volume (storing unit 401) using the information about the physical connection state (path) between the servers A and B and the RAID device 10 is realistic and effective especially in the blade system.

Besides, just by changing the setting of the host LUN correspondence information 143, the volume information 142, and the RAID group information 141 in the RAID device 10, it is possible to set and change the access area corresponding to the server easily. Namely, the access control of the servers A and B to the storing unit 401 may be easily set and changed, which is very convenient. At the same time, without any troublesome configuration of the affinity group, an exclusive access area may be set, which is also convenient.

The disclosed technique is not restricted to the above-mentioned embodiment and various modifications may be made without departing from the spirit of the embodiment.

For example, although the above embodiment describes the storing unit 401 using an HDD as an example, it is not restricted to this but any storing unit other than an HDD may be used as the storing unit 401. Further, although the above embodiment describes the RAID device 10 including five storing units 401, it is not restricted to this and four storing units 401 or less or six or more may be included.

Although the above embodiment describes only the server A for convenience's sake, it is not restricted to this and the server B may have operations similar to the server A.

Although the above embodiment describes the storage system configured by the FC protocol, it is not restricted to this and the embodiment may be applied to a system configured by a protocol other than the FC protocol and various modifications may be made without departing from the spirit of the embodiment.

This embodiment may be carried out and manufactured by those skilled in the art, through the above-mentioned disclosure.

According to the disclosed storage system, storage control device, reception control device, and control method, at least one of the following effects or merits may be obtained.

(1) It is possible to control access to a volume without using the WWN of a host bus adapter of the information processor.

(2) It is possible to reduce the loads for management and operation because there is no need to change any setting and operations even when the WWN of the host bus adaptor is changed in the information processor.

(3) It is possible to set and change an access restriction of the information processor to the storing unit with ease, which is very convenient. All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system, including a storing unit, which is configured to be connectable to an information processor, the storage system comprising:
a communication data receiving unit which receives communication data transmitted from the information processor;
a path information extracting unit which extracts path information indicating a communication path between the information processor that is a transmission source of the communication data and the communication data receiving unit, from the communication data received by the communication data receiving unit;
a specifying information creating unit which creates specifying information indicating the information processor that is the transmission source of the communication data, based on the path information extracted by the path information extracting unit; and
an access controlling unit which performs access control on the storing unit corresponding to the communication data, based on the specifying information created by the specifying information creating unit.

2. The storage system according to claim 1, further comprising:
an access control information storing unit which manages access information for gaining access to a storing region in the storing unit, in correspondence with extended storage access information that includes the path information indicating the communication path between the information processor and the communication data receiving unit, wherein
the access controlling unit performs the access control according to the access information stored in the access control information storing unit.

3. The storage system according to claim 1, further comprising:
a storage access information processing unit which creates processed storage access information that includes the path information indicating the communication path between the information processor that is the transmission source of the communication data and the communication data receiving unit, by adding the specifying information created by the specifying information creating unit to storage access information of the communication data, wherein
the access controlling unit performs the access control, based on the processed storage access information created by the storage access information processing unit.

4. The storage system according to claim 2, further comprising:
a storage access information processing unit which creates processed storage access information that includes the path information indicating the communication path between the information processor that is the transmission source of the communication data and the communication data receiving unit, by adding the specifying information created by the specifying information creating unit to storage access information of the communication data, wherein
the access controlling unit performs the access control, based on the processed storage access information created by the storage access information processing unit.

5. The storage system according to claim 1, further comprising:
a judging unit which judges whether the communication data is a storage access command or not, wherein
the specifying information creating unit creates the specifying information when the communication data is judged to be the storage access command by the judging unit.

6. A storage control device which is configured to be connectable to an information processor, and which controls an access to a storing region of a storing unit, the storage control device comprising:
a communication data receiving unit which receives communication data transmitted from the information processor;
a path information extracting unit which extracts path information indicating a communication path between the information processor that is a transmission source of the communication data and the communication data receiving unit, from the communication data received by the communication data receiving unit;
a specifying information creating unit which creates specifying information indicating the information processor that is the transmission source of the communication data, based on the path information extracted by the path information extracting unit; and
an access controlling unit which performs access control on the storing unit corresponding to the communication data, based on the specifying information created by the specifying information creating unit.

7. The storage control device according to claim 6, further comprising:
an access control information storing unit which manages access information for gaining access to a storing region in the storing unit, in correspondence with extended storage access information that includes the path information indicating the communication path between the information processor and the communication data receiving unit, wherein
the access controlling unit performs the access control according to the access information stored in the access control information storing unit.

8. The storage control device according to claim 6, further comprising:
a storage access information processing unit which creates processed storage access information that includes the path information indicating the communication path between the information processor that is the transmission source of the communication data and the communication data receiving unit, by adding the specifying information created by the specifying information creating unit to storage access information of the communication data, wherein
the access controlling unit performs the access control, based on the processed storage access information created by the storage access information processing unit.

9. The storage control device according to claim 7, further comprising:
a storage access information processing unit which creates processed storage access information that includes the path information indicating the communication path between the information processor that is the transmission source of the communication data and the communication data receiving unit, by adding the specifying information created by the specifying information creating unit to the storage access information of the communication data, wherein
the access controlling unit performs the access control, based on the processed storage access information created by the storage access information processing unit.

10. The storage control device according to claim 6, further comprising:
a judging unit which judges whether the communication data is a storage access command or not, wherein
the specifying information creating unit creates the specifying information when the communication data is judged to be the storage access command by the judging unit.

11. A reception control device comprising:
a communication data receiving unit which receives communication data transmitted from an information processor;
a path information extracting unit which extracts path information indicating a communication path between the information processor that is a transmission source of the communication data and the communication data receiving unit, from the communication data received by the communication data receiving unit; and
a specifying information creating unit which creates specifying information indicating the information processor that is the transmission source of the communication data, based on the path information extracted by the path information extracting unit.

12. The reception control device according to claim 11, further comprising:
a storage access information processing unit which creates processed storage access information that includes the path information indicating the communication path between the information processor that is the transmission source of the communication data and the communication data receiving unit, by adding the specifying information created by the specifying information creating unit to the storage access information of the communication data.

13. The reception control device according to claim 11, further comprising:
a judging unit which judges whether the communication data is a storage access command or not, wherein
the specifying information creating unit creates the specifying information when the communication data is judged to be the storage access command by the judging unit.

14. The reception control device according to claim 12, further comprising:
a judging unit which judges whether the communication data is a storage access command or not, wherein
the specifying information creating unit creates the specifying information when the communication data is judged to be the storage access command by the judging unit.

15. A control method for controlling access to a storing region of a storing unit in a storage control device configured to be connectable to an information processor, the method comprising:
receiving communication data transmitted from the information processor;
a path information extracting operation of extracting path information indicating a communication path between the information processor that is a transmission source of the communication data and the storage control device, from the communication data received in the communication data receiving operation;
a specifying information creating operation of creating specifying information indicating the information processor that is the transmission source of the communication data, based on the path information extracted in the path information extracting operation; and
an access control operation of performing access control on the storing unit corresponding to the communication data, based on the specifying information created in the specifying information creating operation.

16. The control method according to claim 15, further comprising:
an access control information storing operation of managing access information for gaining access to the storing region in the storing unit, in correspondence with extended storage access information including the path information indicating the communication path between the information processor and the storage control device, wherein
the access controlling operation performs the access control, according to the access information.

17. The control method according to claim 15, further comprising:
a storage access information processing operation of creating processed storage access information that includes the path information indicating the communication path between the information processor that is the transmission source of the communication data and the communication data receiving unit, by adding the specifying information created in the specifying information creating operation to the storage access information of the communication data, wherein
the access controlling operation performs the access control, based on the processed storage access information created in the storage access information processing operation.

18. The control method according to claim 16, further comprising:
a storage access information processing operation of creating processed storage access information that includes the path information indicating the communication path between the information processor that is the transmission source of the communication data and the communication data receiving unit, by adding the specifying information created in the specifying information creating operation to the storage access information of the communication data, wherein
the access controlling operation performs the access control, based on the processed storage access information created in the storage access information processing operation.

19. The control method according to claim 15, further comprising:
a judging operation of judging whether the communication data is a storage access command, or not, wherein
the specifying information creating operation creates the specifying information when the communication data is judged to be the storage access command in the judging operation.
